(19) United States
(12) Patent Application Publication
(10) Pub. No.: US 2011/0246686 A1
(43) Pub. Date: Oct. 6, 2011

(54) APPARATUS AND SYSTEM HAVING PCI ROOT PORT AND DIRECT MEMORY ACCESS DEVICE FUNCTIONALITY

(76) Inventors: Edward T. Cavanagh, JR., Eagleville, PA (US); Frederick George Fellenser, Paoli, PA (US); John William Bartholomew, Phoenixville, PA (US); Jia Tong, Chesterbrook, PA (US)

(21) Appl. No.: 12/752,303

(22) Filed: Apr. 1, 2010

(51) Int. Cl. G06F 13/28

(52) U.S. Cl. 710/22

(57) ABSTRACT

An apparatus and system having both PCI Root Port (RP) device and Direct Memory Access (DMA) End Point device functionality is disclosed. The apparatus is for use in an input/output (I/O) system interconnect module (IOSIM) device. A DMA/RP module includes a RP portion and one or more DMA/RP portions. The RP portion has one or more queue pipes and is configured to function as a standard PCIe Root Port device. Each of the DMA/RP portions includes DMA engines and DMA input and output channels, and is configured to behave more like an End Point device. The DMA/RP module also includes one or more PCIe hard core portions, an ICAM (I/O Caching Agent Module), and at least one PCIe service block (PSB). *The hard core portion couples the DMA/RP module and IOSIM device to an I/O device via a PCIe link, and the ICAM transitions data to a host memory device operating system.

### BACKGROUND

1. Field

The instant disclosure relates generally to input/output (I/O) apparatus, systems and processes, and more particularly, to input/output (I/O) apparatus, systems and processes that provide PCI-based Root Port (RP) and Direct Memory Access (DMA) device functionality.

2. Description of the Related Art

In computer emulation and other computing environments that involve data transfer between multiple processors, the input/output (I/O) systems that the processors work with are crucial to the ability to transfer data between the processors and their associated devices. Some I/O systems that work with existing emulation processors and other processors do not function like standard Peripheral Component Interconnect (PCI) or Peripheral Component Interconnect Express (PCIe) bus standard I/O systems. However, many current and next generation I/O systems that work with or will work with existing emulation processors and other processors are or will be based on and/or will function as a standard PCI or PCIe I/O system. Such I/O system disparity or incompatibility could set up potential I/O interface problems when transferring information between a processor having a standard I/O system and a processor having a non-standard I/O system, i.e., an I/O system that does not function like a standard PCI or PCIe I/O system.

### SUMMARY

It would be advantageous to have available a processor module or device that allows existing and future processors to operate in computing environments that may have either or both I/O systems that do not function like standard PCI I/O systems and I/O systems that are or behave like standard PCI I/O systems. Disclosed is an I/O apparatus and system that includes and allows for both PCI Root Port (RP) device and Direct Memory Access (DMA) End Point device functionality. A DMA/RP module includes a Root Port portion and one or more DMA/RP portions. The Root Port portion has one or more queue pipes and is configured to function as a standard PCIe Root Port. Each of the one or more DMA/RP portions includes one or more DMA engines, DMA input channels and DMA output channels, and is configured to behave more like an End Point device. The DMA/RP module also includes one or more PCIe hard IP or hard core portions, an ICAM (I/O Caching Agent Module), and at least one PCIe service block (PSB). The PCIe hard IP or hard core portion handles the PCIe transaction, link and physical layers, and the ICAM transitions data from the non-coherent PCIe space to the coherent space to the host operating system and at least one PCIe service block (PSB).

### BRIEF DESCRIPTION OF THE DRAWINGS

FIG. 1 is a schematic view of a Peripheral Component Interconnect Express (PCIe) topology, according to a conventional arrangement;

FIG. 2 is a schematic view of an input/output (I/O) system interconnect module (IOSIM) device, including a DMA/RP module according to an embodiment;

FIG. 3 is a schematic view of a portion of the DMA/RP module, including the RP portion of the DMA/RP module, according to an embodiment; and

FIG. 4 is a schematic view of a portion of the DMA/RP module, including the DMA portion of the DMA/RP module, according to an embodiment.

### DETAILED DESCRIPTION

In the following description, like reference numerals indicate like components to enhance the understanding of the disclosed invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the disclosure.

In some computing environments, the input/output (I/O) systems that one or more of the processors work with do not function like a standard Peripheral Component Interconnect (PCI) or Peripheral Component Interconnect Express (PCIe) bus standard I/O system. For example, in a computing environment that includes or involves a Master Control Program (MCP) environment having an MCP processor, the I/O systems that the MCP processor works with often are non-standard I/O systems that do not function like standard PCI or PCIe I/O systems. As is known in the art, the MCP is a proprietary operating system used in many Unisys Corporation mainframe computer systems.

As many current and next generation I/O systems are (or at least function as) standard PCI I/O systems, potential interconnectivity problems and other I/O problems can arise for a processor that uses a non-standard (i.e., non-PCI) I/O system when transferring or receiving data from a processor that uses a standard PCI I/O system. Within a computing environment that involves an MCP processor, one potential approach to moving data between the two computing environments could be to make the PCIe link in the non-standard I/O system a PCIe End Point with an integrated direct memory access (DMA). However, a common I/O solution approach that also could be used in a computing environment that uses a standard I/O system would be even more advantageous.

The inventive apparatus described herein includes a Root Port (RP) with integrated Direct Memory Access (DMA) module that can be used with both standard PCI and non-standard PCI I/O systems. As will be described in greater detail hereinbelow, the inventive DMA within a Root Port (DMA/RP) module is designated as a module with one or more PCIe Root Ports. In a standard PCI I/O system, the DMA/RP module PCIe Root Port functions as a standard PCIe Root Port and communicates with the IO Manager on the other end of the PCIe link. In a non-standard PCI I/O system, the DMA/RP module PCIe Root Port uses a built-in DMA and functions more like an End Point device.

In general, the inventive Root Port with integrated DMA module allows non-standard PCI I/O system software (e.g., MCP software) to communicate with the I/O without any PCI specific knowledge. After an initial setup by Maintenance software, the inventive DMA/RP module's subsystem functions without the non-standard PCI I/O system processors (e.g., MCP processors) having to perform any functions that are PCI specific. In operation, the non-standard PCI I/O system software (e.g., MCP software) builds an I/O Control Block (IOCB) and interrupts the DMA/RP module. The DMA/RP module interrupts the standard PCI I/O system via a PCIe MSI interrupt command. The standard PCI I/O system programs the DMA to move the IOCB to its memory. The standard PCI I/O system then interprets the IOCB and determines if data is to be moved to or from the non-standard PCI I/O system memory (e.g., the MCP memory). Based on the IOCB, the standard PCI I/O system then programs another DMA operation to perform the data movement. Once the data movement is complete, the DMA is used one more time to move a status block from the standard PCI I/O system to the non-standard PCI I/O system memory (e.g., the MCP memory). The MCP system then is interrupted and notified that the I/O is complete.

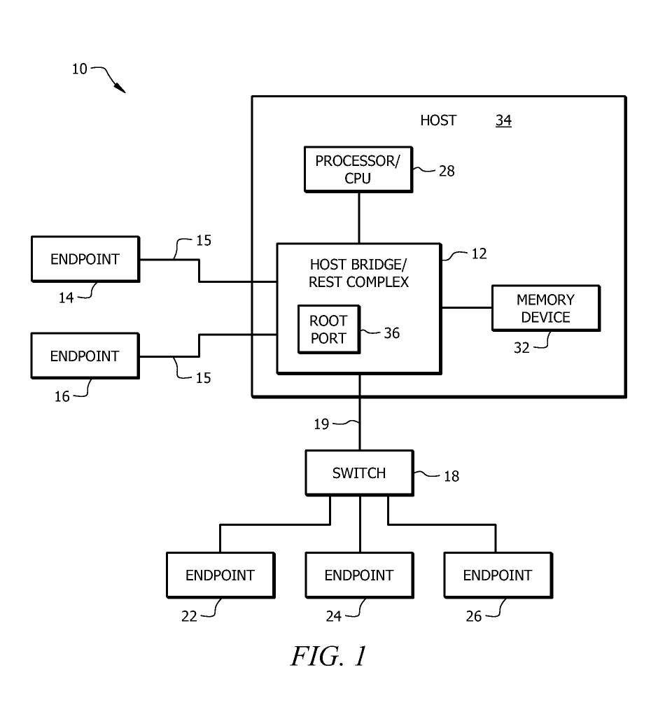

FIG. 1 is a schematic view of a PCIe topology 10 according to a conventional arrangement. The PCIe topology 10 can include a host bridge or root complex 12, and one or more PCIe endpoints 14, 16 (e.g., PCIe enabled I/O adapters or devices) connected to the root complex 12 via individual PCIe links 15. Also, the PCIe topology 10 can include a PCIe switch 18, which is connected to the root complex 12 via a PCIe link 19. The PCIe switch 18 also is coupled to multiple endpoints 22, 24, 26.

The root complex 12 is the root of an I/O hierarchy that connects a CPU/memory subsystem to an I/O system. The root complex 12 may support one or more PCIe ports, e.g., one or more endpoints and/or switches. Each interface with the root complex 12 defines a separate hierarchy domain. Each hierarchy domain may be composed of a single endpoint or a sub-hierarchy containing one or more switch components and endpoints. Also, the root complex 12 can include a real or virtual switch therein (not shown) to enable peer-to-peer transactions through the root complex 12. The root complex 12 can include one or more root ports 36, each of which can originate and support a separate PCIe I/O hierarchy domain from the root complex 12.

Generally, an endpoint, such as endpoint 14, is a type of device that can be the requester or completer of a PCIe transaction, either on its own behalf or on behalf of a non-PCIe device (other than a PCI device or a host CPU). For example, an endpoint can be a PCIe attached graphics controller, a PCIe-USB host controller, or a PCIe attached network interface.

The root complex 12 can be connected to a host processor or central processing unit (CPU) 28 and a host memory device 32. The combination of the root complex 12, the host processor or CPU 28 and the host memory device 32 can be referred to as a host 34.

As discussed hereinabove, one potential approach to moving data between two computing environments, where one computing environment includes a non-standard (PCIe) I/O system, is to make the PCIe link in the non-standard I/O system a PCIe End Point and integrate the DMA functionality into the PCIe End Point. However, such approach is not useful within a computing environment that includes a standard I/O system. Another potential approach is to integrate the DMA functionality into the switch. However, as discussed in greater detail hereinbelow, integrating the DMA functionality into the switch presents several problems that are addressed or even eliminated by the inventive DMA/RP module that integrates DMA functionality into the Root Port.

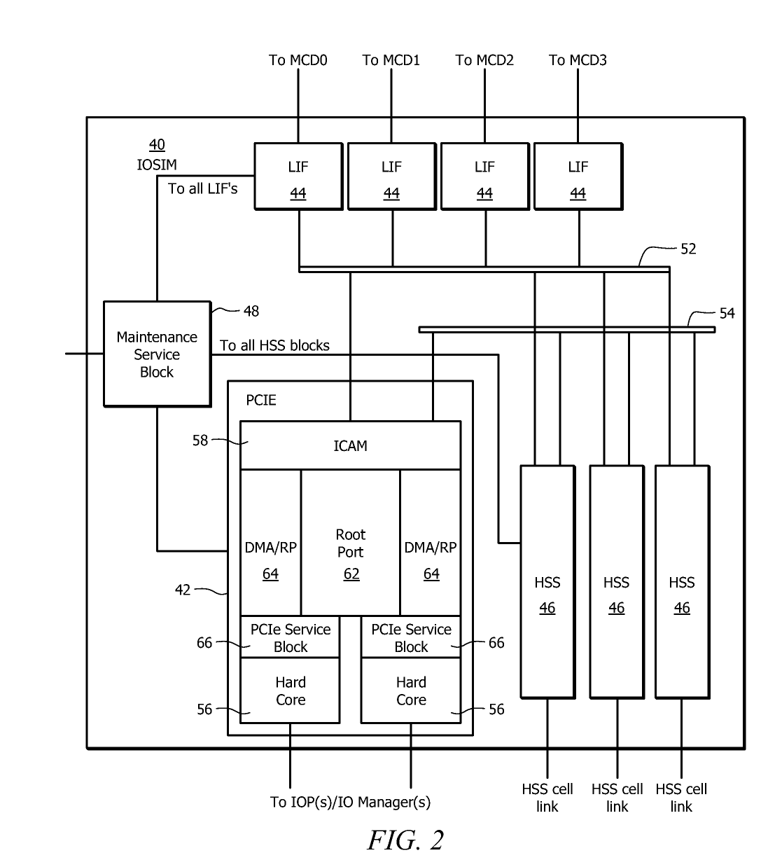

FIG. 2 is a schematic view of an input/output (I/O) system interconnect module (IOSIM) device 40 that includes a DMA/RP module 42 according to an embodiment. The IOSIM device 40 can reside within or is part of a host bridge/root complex. The DMA/RP module 42, which also can be referred to as a PCIe block, is but one of many blocks or modules within the IOSIM device 40. Other blocks or modules in the IOSIM device 40 include one or more Link Interface (LIF) blocks or modules 44, one or more High Speed Serial Links (HSS) blocks or modules 46, and a Maintenance Service block or module 48. The blocks or modules in the IOSIM device 40 are coupled to all other blocks or modules in the IOSIM device 40, either directly, via a first bus 52 or a second bus 54, or via some other suitable coupling arrangement. As will be discussed hereinbelow, the HSS blocks 46 are used only as part of a standard PCI I/O system. The IOSIM device 40 connects to a host memory and one or more host memory control devices (MCDs) via the LIF blocks 44. The IOSIM device 40 also connects to I/O devices and their I/O processors (IOPs) and I/O managers, e.g., through a non-transparent (NT) bridge (not shown), via one or more I/O components within the DMA/RP module 42.

The DMA/RP module 42 includes one or more PCIe hard IP implementations or hard core logic block portions 56. Each hard core portion 56 handles the corresponding PCIe transaction, link and physical layers. Data is supplied to and received from the hard core portion 56 in PCIe Transaction Layer packets (TLPs). The hard core portion 56 connects the DMA/RP module 42 to I/O devices and their IOPs and I/O managers, e.g., through a non-transparent (NT) bridge (not shown). The DMA/RP module 42 also includes an ICAM (I/O Caching Agent Module) 58. The ICAM 58 transitions data from the non-coherent PCIe space to the coherent space to the host operating system, via the LIF blocks 44 and the host memory MCDs.

The DMA/RP module 42 also includes a Root Port (RP) portion 62 having one or more queue pipes, as will be discussed in greater detail hereinbelow. Each of the Root Port portions 62 allows the DMA/RP module 42 and the IOSIM device 40 to function as a standard PCIe Root Port. For example, the Root Port portions 62 allow the DMA/RP module 42 and the IOSIM device 40 to originate or be the source of various command and status requests, such as Configuration requests, to one or more end point devices coupled to the IOSIM 40. In this manner, the IOSIM 40 device operates in a standard PCIe Root Port (RP) mode.

The DMA/RP module 42 also includes one or more DMA/RP portions 64, which each include one or more DMA engines, DMA input channels and DMA output channels, as will be discussed in greater detail hereinbelow. Each of the DMA/RP modules 42 includes built-in DMA functionality to allow the DMA/RP module 42 and the IOSIM device 40 to behave more like an end point device even though the IOSIM device 40 is a root port device. For example, the DMA/RP portions 64 allow the DMA/RP module 42 and the IOSIM device 40 to generate data movement requests, memory Reads and Writes, and other functions typically performed by end point devices. In this manner, the IOSIM 40 device operates in a non-standard DMA/RP mode.

The mode of operation of the DMA/RP module 42 can be determined or established in any suitable manner. For example, changing the mode of operation of the DMA/RP module 42 between the standard PCIe Root Port (RP) mode and the non-standard DMA/RP mode can be performed by switching a pin strap setting within the DMA/RP module 42. It should be understood that other suitable methods for changing the mode of operation of the DMA/RP module 42 are possible.

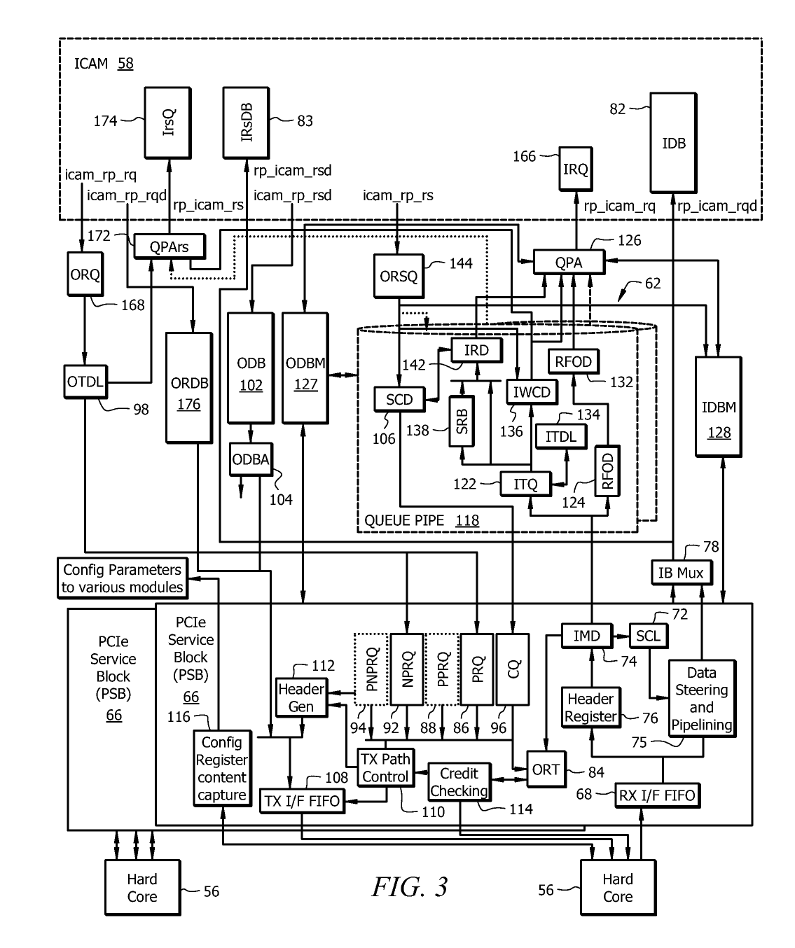

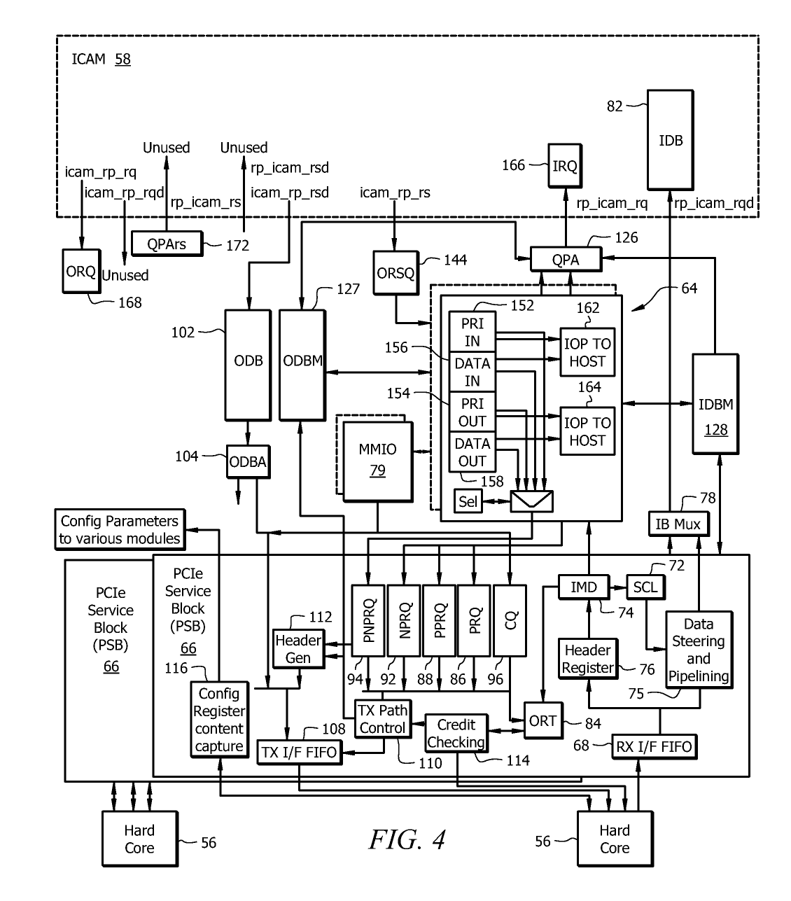

The DMA/RP module 42 also includes one or more PCIe service blocks (PSBs) 66 coupled between the hard core portion 56 and both the Root Port portion 62 and the DMA/RP portions 64. FIG. 3 is a schematic view of a portion of the DMA/RP module 42, showing the Root Port portion 62 and the PSB 66 in greater detail, as is used in allowing the IOSIM device 40 to operate in the standard PCIe Root Port (RP) mode. FIG. 4 is a schematic view of a portion of the DMA/RP module 42, showing the DMA/RP portion 64 and the PSB 66 in greater detail, as is used in allowing the IOSIM device 40 to operate in the non-standard DMA/RP mode.

It should be understood that all or a portion of the DMA/RP module 42 can be partially or completely configured in the form of software, e.g., as processing instructions and/or one or more sets of logic or computer code. In such configuration, the logic or processing instructions can be stored in a data storage device, and accessed and executed as one or more applications within an operating system by a processor. Alternatively, all or a portion of the DMA/RP module 42 can be partially or completely configured in the form of hardware circuitry and/or other hardware components within a larger device or group of components, e.g., using specialized hardware elements and logic.

A description of the PCIe service blocks (PSBs) 66 follows. The PSBs 66 have many components that are used in the same manner in both modes of operation of the IOSIM device 40, i.e., the standard PCIe Root Port mode and the non-standard DMA/RP mode. There is one PSB 66 per PCIe link, with a corresponding PCIe hard IP or hard core portion 56 therebetween. Each PCIe hard core portion 56 takes care of most of the transaction layer and below functionality. The PCIe configuration registers reside in the hard core portions 56. The hard core portions 56 are configured as Root Ports, therefore, the upper level of the IOSIM device 40 (i.e., the LIFs 44) does not receive Configuration or I/O requests, but only receives host Memory Reads and Memory Writes. The transmit side of the IOSIM device 40 is capable of sending Memory, I/O or Configuration requests. Configuration requests from the ICAM 58 can target either the configuration registers in the hard core portion 56 itself or the device(s) at the other end of the link. The PSB 66 has 5 queues for handling TLPs destined for the PCIe link. There are Posted, Non-Posted and Completion queues for handling all of the TLPs that the standard Root Port generates. There are Priority Posted and Priority Non-Posted queues for DMA Descriptor Fetch operations and DMA Descriptor Writeback operations. These “priority” queues are used only when the PSB 66 is operating in the non-standard DMA/RP mode.

The PSB 66 includes a receive (RX) Interface (I/F) FIFO 68, which interfaces directly with the corresponding hard core portion 56. Header and data information enters the IOSIM device 40 through the RX I/F FIFO 68. Data output from the RX I/F FIFO 68 travels to a header path, and also to a parallel path while the ultimate destination for the data is determined.

Data received by the PSB 66 from the hard core portion 56 is not formatted, as the received data is arranged in the host memory. However, some rearrangement of data words may be required. Pipelining, e.g., via a data steering and pipelining component 75, is needed so that data continues to be received at the “line rate” while the data header is examined to determine the destination for the data. The hard core portion 56 does not fault or overflow if there is a stall in taking data, but if most or every request is stalled while a few clocks are taken to examine the header and determine the destination for the data, then throughput will be adversely affected. The PSB 66 includes a steering control logic (SCL) component 72, which determines where the data is sent. The SCL component 72 is set up by an inbound message/header decode (IMD) component 74 coupled thereto.

The PSB 66 includes a header register 76, which captures the first four (4) doublewords (DWs) of a TLP. TLPs without data signify the complete TLP. The contents of the header register 76 is aligned such that the TLP header starts in DW0. To maintain data flow on the RX I/F FIFO 68, pipelines process the headers in the IMD 74. The IOSIM device 40 should receive Memory Read, Memory Write and Completion TLPs. Memory Write and Completion TLPs have data associated with them.

The steering control logic 72 controls the steering/writing of the data to an inbound buffer (IB) Mux 78, the DMA engines in the DMA/RP portion 64, or a Memory Mapped IO (MMIO) register access block 79. When the IOSIM device 40 is in the non-standard DMA/RP mode, e.g., as shown in FIG. 4, the Completions for requests from the Priority NP Queue (Descriptors) go to DMA channels, while Completion data from the regular NP Queue (data and IOCB Writeback information) flows to the IB Mux 78 to be sent to an Inbound Data Buffer (IDB) 82, which is located in the ICAM 58. MMIO Write data goes to the MMIO register access block 79. When the IOSIM device 40 is in the standard PCIe Root Port mode, e.g., as shown in FIG. 3, Memory Write data is sent to the IB Mux 78 and is destined for the IDB 82. Completion data also is sent to the IB Mux 78, but its destination from there is an Inbound Response Data Buffer (IRsDB) 83, which is located in the ICAM 58.

The inbound message/header decode (IMD) component 74 is responsible for decoding inbound transactions to the PCB 66. When the IOSIM device 40 is in the non-standard DMA/RP mode, e.g., as shown in FIG. 4, the IMD 74 forwards PCIe Read and Write request headers and BAR decode information to the MMIO register access block 79. MMIO Reads and Writes can be made to chip-specific registers, e.g., located locally within the hard core portion 56, and to the Control/Status Register (CSR) ring for more global access. If the MMIO register access block 79 receives a request for an unknown address, the MMIO register access block 79 reports the “unsupported request” to the PSB 66.

The IMD 74 processes Completion headers. Every Completion should have a Tag that correlates to a valid entry in an Outbound Request Tracker (ORT) 84. The IMD 74 captures data routing information from the ORT 84 and sets up the data steering logic so that the Completion data is sent to the appropriate destination. Completion data can be destined to the DMA channels (descriptors) or to the IB Mux 78, with MCP input data going to the IDB 82.

When the IOSIM device 40 is in the standard PCIe Root Port mode, e.g., as shown in FIG. 3, the IMD 74 forwards PCIe Read/Write and Completion header information to the PCB queue pipes, which are discussed in greater detail hereinbelow. Also, PCIe Write data is sent to the IB Mux 78 and is destined for the IDB 82. Also, Completion data is sent to the IB Mux 78, but is destined for the IRsDB 83 located in the ICAM 58.

The PSB 66 has a plurality of queues: a Posted Request Queue (PRQ) 86, a Priority Posted Request Queue (PPRQ) 88, a Non-Posted Request Queue (NPRQ) 92, a Priority Non-Posted Request Queue (PNPRQ) 94, and a Completion Queue (CQ) 96. The PRQ 86 receives Posted transactions (i.e., PCIe memory writes) from a DMA output engine (in the non-standard DMA/RP mode) or an Outbound Transaction Dispatch Logic (OTDL) component 98 (in the standard PCIe Root Port mode) that are destined for the PCIe Link and the IOP/IO Manager. The PRQ 86 can be four (4) entries deep and specifies the information required to build a PCIe TLP header. The TLP header includes IOP memory address, length and other TLP header information. No requests are allowed to pass each other in the PRQ 86. The data is pulled from an Output Data Buffer (ODB) 102 via an Outbound Data Buffer Access (ODBA) component 104. The OTDL 98, the ODB 102 and the ODBA 104 will be discussed in greater detail hereinbelow.

In the non-standard DMA/RP mode, the PPRQ 88 receives Priority Posted transactions (i.e., PCIe memory writes) that are destined for the PCIe Link and the IOP/IO Manager. The PPRQ 88 is not used in the standard PCIe Root Port mode. Priority Posted transactions are requests from DMA channels within the DMA/RP portion 64. These memory writes contain Descriptor Writeback information. The PPRQ 88 is four (4) entries deep and specifies the information required to build a PCIe TLP header. The TLP header includes IOP memory address, length and other TLP header information. Also, the DMA channel that originated the request also is indicated with the request. The data is pulled from the appropriate DMA channel in a FIFO (first in, first out) manner. As with the PRQ 86, no requests are allowed to pass each other in the PPRQ 88. If there are insufficient credits to handle the top request, the entire PPRQ 88 stalls. When the PPRQ 88 is serviced, the header is built and data is pulled from the appropriate DMA channel, e.g., in 16 byte increments. Descriptor length can be 32 byte or 64 bytes, therefore a Writeback can require two or four transfers from the DMA channel to get the Descriptor to write back.

The NPRQ 92 contains memory reads destined for the PCIe Link and IOP/IO manager memory. In the non-standard DMA/RP mode, a DMA input engine generates requests for the NPRQ 92. The queue entries contain information related to the IOP memory address and read request length. It is the responsibility of the DMA input engine to know the “Max Read Request” size and to generate requests having a length no greater than the Max Read Request size. The DMA input engine also must indicate a request number. The request number is stored in the ORT 84 and included on all notifications to the DMA engine as data is sent to the IB Mux 78 to be stored in the IDB 82. The DMA engine collects the Completion notifications and generates Writes to the ICAM 58 for the Completion data in the IDB 82. The request number allows the DMA engine to generate multiple Read requests and for those Read requests to be outstanding on the link and their data to be returned out of order with respect to each other. By comparison, data for a single request must always be returned in order per the PCIe standard specification.

In the standard PCIe Root Port mode, requests for the NPRQ 92 originate at the host processor and come to the NPRQ 92 via the OTDL 98. These NPRQ 92 memory Reads should not exceed 32 bits in length and should not cross a 64 byte boundary. These limits prevent “split” Completions for a single request. Completion data is routed via the IB Mux 78 to the IRsDB 83 located in the ICAM 58.

The PNPRQ 94 contains memory Reads destined for the PCIe Link and the IOP memory. The PNPRQ 94 is used only in the non-standard DMA/RP mode; the PPRQ 88 is not used in the standard PCIe Root Port mode. The DMA channels generate requests for the PNPRQ 94, in the form of descriptor Fetches. The queue entries contain information related to the IOP memory address and read request length. If multiple contiguous descriptors are to be fetched, each request may be for up to 256 bytes. It is the responsibility of the DMA channel to know the Max Read Request size and to generate requests having a length no greater than the Max Read Request size, although generated requests are not expected to be smaller than 256 bytes (the PCIe default is 512). The DMA channels can request descriptors individually or in grouped requests. A request number and channel ID field are provided so that multiple descriptor Fetches can be supported if the DMA channel has enough information to request multiple independent descriptors. These fields are stored in the ORT 84 and included on signals back to the DMA channels when data is being sent. The data return to the DMA channels are bussed to all channels, and each channel uses the ID field to qualify whether the return data is intended for that particular channel. Such process simplifies the configuration for the IMD 74 in that the IMD 74 only needs to find out from the ORT 74 if the request originated from the NPRQ 92 or the PNPRQ 94, and then route the data either to the IB Mux 78 or to the DMA channels.

The CQ 96 contains Completions destined for the PCIe Link and the IOP. In the non-standard DMA/RP mode, the IOP requests only MMIO reads, i.e., the data associated with the Completions always comes from the MMIO register access block 79. Data is taken from the MMIO register access block 79 in a FIFO manner. Only the information needed to build the Completion header needs to be in this queue. The Completion header information is complete enough for the PSB 66 to pull the right amount of information from the MMIO register access block 79. The MMIO register access block 79 detects and signals any under-run.

In the standard PCIe Root Port mode, a split Completion dispatcher (SCD) 106 in the queue pipe writes the Completion queue. In this mode, data is in the ODB 102. The CQ 96 contains information about the location and length of the data to be sent. Also, the SCD 106 calculates the remaining byte count and records it in the CQ 96 so that the appropriate information can be supplied to the PCIe Completion header.

The ORT 84 tracks PCIe-bound Non-Posted requests. When Completions are received on the RX interface, the ORT 84 is interrogated to determine the appropriate destination. In the non-standard DMA/RP mode, the IMD 74 is responsible for freeing the ORT 84 entry when the final Completion for a request is received. There also is a final Completion indication that goes to the DMA engine when the Completion is received. All received Completions are checked against the ORT 84 by the IMD 74.

In the standard PCIe Root Port mode, all Non-Posted requests should be less than 32 bits (4 bytes) and should not cross a 64 byte Read Completion boundary. Therefore, the Completions are always just a single Completion. The data is destined for the IB Mux 78 and then sent to the IRsDB 83 located in the ICAM 58. The Completion information is sent to the queue pipe associated with this link.

In all modes, if the IMD 74 does not find a valid entry corresponding with the Tag, the IMD 74 signals to the hard core portion 56 that the IMD 74 received an “unexpected Completion,” and the hard core portion 56 logs the error and sends an error message to the IOP. The “unexpected Completion” error does not set an additional error that is in the error hierarchy that generates a service requirement (SRQ). However, the “unexpected Completion” error does set an additional error that is sent to a maintenance processor, e.g., via the Maintenance Service block 48.

The ORT 84 has a programmable timer for a Completion Timeout mechanism, as is described in the PCIe standard specification. The hard core portion 56 is configured so that its Device Capabilities 2 register reports the values for which the timer can be programmed. The Device Control 2 register is captured off of the tl_cfg lines and reported to the ORT 84 by a “Config Register Content Capture” block 116, which is described in greater detail hereinbelow. Each entry in the ORT 84 should be timed independently. Also, the Completion timeout mechanism can be totally disabled in the Device Control 2 register. In such configuration, when a request times out, the ORT 84 clears the valid indication, retires the Tag, and signals “Completion timeout” on the cpl_err lines.

The PSB 66 also includes a TX Interface (I/F) FIFO 108, which is the last stage where TLP data destined for the IOP passes. The TX I/F FIFO 108 interfaces directly with the tx_st signals to the hard core portion 56. The header information is built prior to being loaded in the TX I/F FIFO 108, and any data that is needed to follow the header is available after being pulled directly from the DMA engine, channels, or MMIO Register Access blocks 79. The data follows a header when a Posted or Completion queue entry is being serviced. This data flow is controlled by a TX Path Control block 110.

The PSB 66 also includes a Header Generator (Header Gen) 112, which generates the PCIe Transaction layer header. The Header Gen 112 is controlled by the TX Path Control block 110. The Header Gen 112 is configured to be able to service a Non-Posted Request queue entry every two (2) clock cycles, and sufficient parallelism is built into the Header Gen 112 to achieve this service capability. The extra clock cycle becomes available by Link Protocol overheads that are appended by the hard core portion 56. By maintaining this entry service rate, the Header Gen 112 is not a bottleneck that inserts additional dead cycles on the PCIe link.

The TX Path Control block 110 is responsible for arbitrating between the queues 86-96 in the PSB 66 and selecting the next outbound action to be sent to the hard core portion 56. The hard core portion 56 provides visibility to the available credits on the interface to the hard core portion 56. The PSB 66 also includes a Credit Checking block 114 that monitors available credits on the link. The TX Path Control block 110 checks with the Credit Checking block 114 to assist in the prioritization of which queue to service.

The TX Path Control block 110 also is responsible for generating requests for the data from the appropriate source. In the non-standard DMA/RP mode, data associated with memory Write requests that are in the PRQ 86 come from the ODB 102, so the TX Path Control block 110 generates a request to the ODBA 104. Data associated with memory Write requests that are in the PPRQ 88 are in the DMA channel that generated the request. The TX Path Control block 110 pulls the data from the particular DMA channel to build the TLP. Data associated with Completion requests comes from the MMIO register access block 79. These Completions can be a maximum of 32 bits in length.

The Credit Checking block 114 maintains a count of headers and data sent to the hard core portion 56. The hard core portion 56 provides visibility into the number of credits granted on the link. From this information, the PSB 66 determines if there are credits available on the link to send the next request of a particular type. For the purpose of the Credit Checking block 114, it does not matter whether or not the hard core portion 56 has actually sent a prior request on the link. The IOSIM 40 does not send a request to the hard core portion 56 if there are not sufficient credits on the link for the request to be sent out of the hard core portion 56. The Credit Checking block 114 assists the TX Path Control block 110 in determining if there are sufficient credits available to send a request on the link.

The PSB 66 also includes the Config Register Content Capture block 116, which is responsible for recording the state of the PCIe Config Registers. Other blocks within the PSB 66 and elsewhere in the IOSIM 40 need to know the contents of the PCIe Config Registers, e.g., registers such as the “Max Read Request size” register, the “Max Payload” register and the “Completion timeout programming” register. The hard core portion 56 has an interface that cycles through the contents of various Config Registers, including a Device Control register.

With respect to interrupt moderation, it should be understood that any interrupt moderation in the IOSIM 40, if required, is used only in the non-standard DMA/RP mode.

Within the Root Port portion 62 of the DMA/RP module 42, the PCI ordering is maintained through one or more queue pipes (QPs) 118. As shown in FIG. 3, the queue pipes 118 are directly connected to a single PSB 66. Thus, there can be two (2) queue pipes 118 in the IOSIM 40, one for each link (PSB). The queue pipes 118 are used when the IOSIM 40 is in the standard PCIe Root Port mode.

Each queue pipe 118 includes an Inbound Transaction Queue (ITQ) 122. All transactions from the PSB 66, except requests for ownership (RFOs), are held in the ITQ 122. The ITQ 122 contains all Writes, Reads, and Completions. There are no RFOs because all requests are checked using a length cyclic redundancy check (LCRC) by the link layer of the hard core portion 56 before the requests are sent up to the IOSIM 40.

The queue positions in the ITQ 122 can be occupied by various combinations of memory Writes or messages, memory Reads, and Completions. The ITQ 122 provides a full indication of queue contents back to the PSB 66, which then stalls (drop ready) the RX path to the hard core portion 56. The hard core portion 56 manages the Flow Control credits such that the hard core portion 56 does not overflow its Receive buffer should the stall last for a relatively prolonged period.

The ITQ 122 has one queue location that is used for each request received on the PCIe link. On message Writes and “no snoop” (NS) Writes (NcWr), codes sent from the PSB 66 to a request for ownership queue (RFOQ) 124 insert an NOP (no operation) command or instruction. The NOP command or instruction goes to a queue pipe arbiter (QPA) 126 (discussed hereinbelow), and causes a count increment. This activity creates and holds a control logic (CL) location in the ICAM 58 for the NcWr or the Message. This process avoids a potential deadlock in situations where later RFOs could consume all available cache-line locations in the ICAM 58. The number of requests received by the ITQ 122 depends on the number of credits the hard core portion 56 advertises and how quickly the hard core portion 56 turns around credits after sending a request up to the PSB 66. Because these requests cannot be regulated using the PCIe flow control mechanism, the RX pipe is configured to be capable of being stalled if there is no room in the ITQ 122 or if there is no available buffer space to put the data associated with a request.

Also, it should be understood that the upper address bits do not flow through the queue pipes 118. Instead the upper address bits bypass the queue pipes 118 and are stored in an outbound data buffer manager (ODBM) 127 and an inbound data buffer manager (IDBM) 128.

The RFOQ 124 queues Request For Ownership (RFO) transactions. The RFOQ 124 can be 32 bits deep by 42 bits wide. The bit layout of the RFOQ 124 can be the same as the bit layout of the ITQ 122. On relatively small Writes, the PSB 66 sends an RFO/WR command. This command creates an entry in both the ITQ 122 and in the RFOQ 124. Only RFO NOP or RFO/WR commands get routed to the RFOQ 124.

Each queue pipe 118 also includes a Request For Ownership Dispatcher (RFOD) block 132. The inbound Write requests are written to the RFOD 132 for early generation of the RFO transactions. The RFOD 132 retrieves the entry at the head of the RFOQ 124 and can generate one (1) to three (3) RFO requests to the ICAM 58. The number and type of RFO requests generated is based on the length, the address, and the start and end Byte Enable (BE) fields. Neither the RFO requests nor the RFOD 132 needs to check if there is control logic available in the Inbound Buffer; the PSB 66 stalls the link and holds the request if there is not.

When an NOP command or instruction reaches the RFOD 132, the RFOD 132 sends the NOP command or instruction to the QPA 126, which counts the NOP command or instruction like it would an RFO request. The QPA 126 then discards the NOP command or instruction, and nothing is sent to the ICAM 58 for the NOP command or instruction. An NOP command or instruction also may be sent to the QPA 126 when an RFO request arrives with the NS bit set. Rules for how Read/Write and RFO requests are made and handled are described in greater detail hereinbelow.

Each queue pipe 118 also includes an Inbound Transaction Dispatcher Logic (ITDL) component 134. The ITDL 134 processes the inbound requests. The ITDL 134 sends the Writes and Completions to an Inbound Write/Completion/Cancel Dispatcher (IWCD) 136. The ITDL 134 sends the Read requests to a Stalled Read buffer (SRB) 138 or to an Inbound Read Dispatcher (IRD) 142.

The IWCD 136 processes the inbound Write and Completion requests. These requests are broken down to cache-line (CL) requests by the IWCD 136. The IWCD 136 includes two (2) up-down counters: an RFO issued counter and a Write pending counter. The IWCD 136 uses both counters to determine if a request can be made.

The IWCD 136 increments the RFO issued counter when an RFO request is sent from the RFOD 132 to the QPA 126. The IWCD 136 decrements the RFO issued counter when a Write request is sent from the RFOD 132. A Write request can be sent to the QPA 126 only when the RFO issued counter has a non-zero value.

The IWCD 136 increments the Write pending counter when a Write request is issued to the QPA 126. The IWCD 136 decrements the Write pending counter when a Write Completion is returned to an outbound response queue (ORSQ) 144. If the Write active at a Write dispatcher within the IWCD 136 is strongly ordered, then the Write pending counter should be zero before the Write is issued. When a strongly ordered Write is broken up into multiple cache-line Writes, each Write should have the Request for Ownership (RO) bit equal to zero (0). This activity forces strict ordering of the Write data. Thus, no Write data passes any prior Write data, even within a single request. Rules for how Read/Write and RFO requests are made and handled are described in greater detail hereinbelow.

Messages also flow to the IWCD 136. The IWCD 136 is responsible for converting messages encoded into the Start and End Byte enable (BE) fields into the message code that the ICAM 58 expects. Messages and NcWr commands destined for the ICAM 58 have NOP commands associated with them in the RFO queue. The NOP commands cause the QPA 126 to increment the RFO counter and do nothing else. This activity holds an open control logic area in the ICAM 58. An RO disable bit causes the IWCD 136 to ignore the state of the RO bit in the header and to treat all Writes as if the RO bit equals zero (0).

The stalled Reads from the ITQ 122 are queued in the SRB 138 so that the Write requests make forward progress. The SRB 138 can be configured to hold a maximum of sixteen (16) Read requests. This Read request capacity insures that even if sixteen Read requests are channeled to one queue pipe, Writes and Completions can bypass them. If the SRB 138 is full, the ITQ 122 is blocked and can back up to the PSB 66, causing the link to stall.

If a relatively “small” Read dispatcher is implemented, a relatively “small” SRB can be implemented in parallel with the SRB 138. The small SRB would take Reads less than 256 bytes (or some smaller programmed limit; 512 bytes is a reserved value because there are many complications involved in handling two output buffers with a single small Read). The small SRB can be at least 4 locations deep. Some benefits of a small SRB (and a small IRD) are discussed hereinbelow.

The IRD 142, in operation, gets loaded with a single PCIe-originated memory Read, which can have a size up to 4096 bytes. First, the IRD 142 makes sure there is a Completion buffer queue available in the SCD 106. Then, the IRD 142 makes requests to the ODBM 126 for buffer space. As the IRD 142 gets buffer space, the IRD 142 makes Read requests to the ICAM 58 in cache-line increments. Suitable address bits, e.g., address bits 7 and 6, determine the cache-line relative area in the output buffer where the data is placed. The IRD 142 uses all 4 cache-line areas of the output buffer, if the length requires, regardless of the starting address location. After the request is made, information pertaining to the request is given to the SCD 106 so that the SCD 106 can track ICAM Completions and forward them to the PSB 66. Rules for how Read/Write and RFO requests are made and handled are described in greater detail hereinbelow.

Relatively small Reads are handled in the IRD state machine and are allowed to be serviced in an interleaved fashion with relatively large Reads whenever a relatively large Read needs to get a new output buffer. Such interleaving benefits performance by providing a quicker turnaround of relatively small requests, thus helping to prevent stalls of the link.

The SCD 106, in operation, collects the data for the inbound requests, and dispatches the data to the PSB 66. The SCD 106 is given PCIe Transaction numbers coupled with ICAM Transaction numbers (OutBufIDs). When a Completion is received from the ICAM 58, the Completion is checked against the PCIe Transaction number to see if a full PCIe Completion can be sent. When all of the Completions associated with that ICAM buffer area have been received, the following information is sent to the PSB 66 so that the Completion can be sent on the PCIe interface: the ICAM buffer area number, the first cache-line (CL) offset, the length and the PCIe transaction number.

The IRD 142 tries to make requests to use all cache-line areas regardless of the first CL offset in the buffer area. If the Max Payload size is 128 bytes (not 256 bytes), the SCD 106 still waits until all cache-line requests for a buffer have been received and then, if more than two (2) cache-line requests were sent, the SCD will send two (2) Completion indications to the PSB 66 in address ascending order. It should be noted that, depending on the absolute address, the cache-line requests sent with the first Completion from a buffer may be the first two cache-line requests, the last two cache-line requests or the middle two cache-line requests. The SCD 106 also uses the error indication provided by the queue pipe 118, and relays the error indication to the Completion queue of the PSB 66. The following information is relayed to the PSB 66: Unsupported Request (UR), Completer Abort (CA), and Report to link indication. The Report to link indication is signaled only on the first Completion that had an error indicated by the ODBM 126. All subsequent errors are given to the PSB 66 but not sent to the Link. The PSB 66 uses the Completion indication only to free OutBufIDs.

The SCD 106 has four (4) Completion queues: two (2) relatively large Completion queues that can be capable of handling enough buffers for a 4K byte Read request, and two (2) relatively small Completion queues that can be capable of handling up to a 512 byte Read request. The SCD 106 also has two (2) output buffers. When the IRD 142 starts to process a new request, the IRD 142 first retrieves an SCD queue. The IRD 142 requests a queue and provides a PCI Read TxnID and the total byte count. The SCD 106 acknowledges with a queue number (i.e., 0-4) if an appropriate queue is available.

The configuration and operation of the DMA/RP portion 64 will be described. As discussed hereinabove, each DMA/RP portion 64 includes one or more DMA engines, DMA input channels and DMA output channels. The DMA engines and DMA channels are used only in the non-standard DMA/RP mode. Data transferred between IOP memory and the host memory (e.g., the MCP memory) is done by using the DMA channels and the DMA engines within the DMA/RP portion 64. The DMA/RP portion 64 can includes four (4) DMA channels and two (2) DMA engines. The DMA channels include a Priority In channel 152, a Priority Out channel 154, a Data In channel 156, and a Data Out channel 158. The DMA engines include a DMA input engine 162 and a DMA output engine 164. It should be understood that “In” and “Out” are relative to the host memory (e.g., the MCP memory), so “In” is from the IOP to the host device and “Out” is from the host device to the IOP.

The DMA engines 162, 164 use the same Input Data Buffer (IDB 82) and Output Data Buffer (ODB 102) that are used by the queue pipes in the standard PCIe Root Port mode. The IDB 82 is where Completion data for DMA-issued Reads to IOP memory ends up. After the data is in the IDB 82, the DMA engine generates Writes to the ICAM 58 and the host memory. The ODB 102 is where the ICAM 58 puts data that is returned from DMA-issued Reads of the host memory. After the data is received, the DMA generates Writes to the PCIe link and the IOP to transfer the data to IOP memory.

The two DMA output channels (the Priority Out channel 154 and the Data Out channel 158) are equal in priority and their data requests on the PCIe side go to the PRQ 86. On the host side (e.g., the MCP side), data Reads destined for the Processor Memory Modules (PMMs) are issued to the ICAM 58. Descriptor Fetch commands go to the PNPRQ 94 and descriptor Writebacks go to the PPRQ 88. The DMA channel waits for confirmation from the PSB 66 that a data request made it to the hard core portion 56 prior to sending the descriptor Writeback. This delay also insures that the Writeback does not pass the data, as they use separate queues in the PSB 66.

Because there are two (2) DMA output channels, one possible implementation is to use one DMA output channel for small traffic, such as IOCBs and Request/Address Queue type information, while using the other DMA output channel for larger data moves. However, other suitable implementations are possible, and there are no structures that favor using one DMA output channel over another for any particular purpose. Both DMA output channels use the DMA output engine 164 for the actual information moves.

Each DMA output channel has a unique tail pointer register, and there also can be a unique circular queue associated with the tail pointer register. Also, each DMA output channel has a base register, which needs to be setup prior to any use. The base register contains the “top” of the circular queue. The lower twelve (12) bits of this register are fixed at zero (0), which requires that a circular queue start on a 4K Windows page boundary. The base register can be 64 bits in size, with the upper 32 bits used in association with the circular queue structures. Thus, the location of a circular queue can be limited such that circular queue is totally contained within a 4 gigabit (GB) range. The use of the circular queue mechanism requires one additional register, which specifies the queue depth so that hardware will know the wrap point. This additional register specifies the number of 4K pages that the circular queue consumes.

Each DMA output channel is able to fetch eight (8) control descriptors so that it can stage work for the DMA output engine 164. As stated previously herein, the DMA output channels use the PPRQ 88 and the PNPRQ 94 in the PSB 66 for fetching and writing back control descriptors. When fetching descriptors, the DMA output channel provides dedicated write access into its descriptor storage structure (or a FIFO) for the PSB 66 to dump data, e.g., at 16 bytes per clock. Such provision prevents backups on the RX path from the hard core portion 56 that could limit throughput. When writing back completed descriptors to the IOP, the DMA output channel uses the PPRQ 88. Descriptor Writeback data is supplied to the PSB 66 at a rate of 16 bytes per clock when demand-pulled by the PSB 66. This prevents unrecoverable overheads from being designed into the TX path. The demand pull happens when the Writeback gets to the head of the PPRQ 88 and is being serviced by the PSB 66.

As with the two output DMA output channels, the two DMA input channels (the Priority In channel 152 and the Data In channel 156) are equal in priority to each other. Their data requests (Reads) on the PCIe side all go to the NPRQ 92. On the host (e.g., MCP) side, data Writes destined for the PMMs are issued to the ICAM 58. Descriptor Fetches go to the PNPRQ 94 and descriptor Writebacks go to the PPRQ 88. The DMA input channels wait for confirmation from the ICAM 58 that a data request is globally visible prior to sending the descriptor Writeback.

Because there are two (2) DMA input channels, one possible implementation is to use one DMA input channel for small traffic, such as IOCB and Request/Address Queue type information, while using the other DMA input channel for larger data moves. However, other suitable implementations are possible, and there are no structures that favor using one DMA input channel over another for any particular purpose. Both DMA input channels use the DMA input engine 162 for the actual information moves.

All four (4) DMA channels use the PPRQ 88 and the PNPRQ 94 for descriptor Fetches and Writebacks. Also, all four DMA channels have identical requirements to source or sink data, e.g., at 16 bytes per clock, when required by the PSB 66, as described hereinabove.

The DMA input engine 162 is responsible for data movement from the IOP memory to the host memory (e.g., the MCP memory). As such, the DMA input engine 162 generates PCIe Read Data requests and places them in the NPRQ 92.

Because the IDB 82 can be 32K bytes in size and is organized as two 16K byte buffers, the DMA input engine 162 in each DMA/RP portion 64 has exclusive use of one of the 16K byte buffers. The DMA input engine 162 is capable of working on four (4) descriptors at a time, so the DMA input engine 162 reserves a 4K block for the maximum Read for each of these blocks. The DMA input engine 162 conveys to the PSB 66 what area of the IDB 82 should be used by the TxnID that is assigned. The PSB 66 notifies the DMA input engine 162 when Read Completions have been received and their data has been stored in the IDB 82. The DMA input engine 162 has exclusive access to the NPRQ 92, so Completions notifications associated with these requests are sent to the DMA input engine 162.

Because Completions to single requests return data in order, no checker boarding logic is needed to handle a single request. If a descriptor needs to be broken into a plurality of maximum Read requests because of a maximum Read request size, unique Tags can be generated that point the return data to the appropriate position in the buffer.

On the host side (e.g., the MCP side), the DMA input engine 162 generates memory Write requests that the DMA input engine 162 forwards to the ICAM 58. Similar to the interface with the PSB 66, the DMA input engine 162 supplies (in the request) all of the fields required to fill out a WrI_FData or WrI_PData flit header. Also, the DMA input engine 162 provides access to the data required to fill out the data portion of the host system interface Writes.

The DMA input engine 162 can work on up to four (4) descriptors at a time, two from each of the two DMA input channels. Each descriptor can have a 4K area in the data buffer.

The DMA output engine 164 is responsible for data movement from the host memory (e.g., the MCP memory) to the IOP memory. As such, the DMA output engine 164 generates PCIe Write Data requests and places them in the PRQ 86. The DMA output engine 164 has the responsibility that the ODBM 127 has when the DMA/RP module 42 is in the standard PCIe Root Port mode. That is, the DMA output engine 164 allocates space in the ODB 102 prior to making Read requests to the host memory. When the DMA output engine 164 is notified that data has been put in the ODB 102 by the ICAM 58, the DMA output engine 164 generates Write requests to the PCIe link. These requests go to the PRQ 86. The PSB 66 pulls data from the ODB 102 when the PSB 66 builds the Write TLP.

When any of the DMA channels writeback a descriptor that had a “generate interrupt” indicated, the DMA channel follows the Writeback entry that the DMA channel places in the PPRQ 88 with an MSI-X flag. This MSI-X flag identifies the channel that wanted to generate the MSI-X. Because the host system is on the other side of an NT bridge, the message interrupt (i.e., the MSI-X) cannot be set up in the normal manner. Instead, the host system driver sets up the hardware to generate Writes to the MSI-X address. Because message interrupts are memory Writes on the PCIe link, the host system hardware can generate these messages to the IOP even though the message needs to pass through an NT bridge.

The queue pipe arbiter (QPA) 126 is responsible for moving the requests from the queue pipes or DMA components (channels and engines) to an inbound request queue (IRQ) 166. The QPA 126 receives Read requests, Write requests and RFO requests separately from any queue pipes or DMA components. The QPA 126 processes Read requests separately from Write requests and RFO requests. Read requests have their own path within the QPA 126 up to an I/O selector in the path, which is discussed hereinbelow. The QPA 126 snapshots the Write requests and the RFO requests, and then processes the RFO requests before processing the Write requests. If the RFO requests are at the limit, the QPA 126 continues to process Write requests because the queue pipes and the DMA components will not issue a Write unless a corresponding RFO already has been sent. It should be noted that RFO Cancel requests raise a Write request from the queue pipes. The QPA 126 contains two (2) counters and two (2) limit registers, both of which provide additional guidance on the order of handling requests.

Read requests, Write requests and RFO requests are all snapshot separately. A snapshot occurs when the register has a zero (0) value and any request of that type is active. No new snapshot occurs until all of the requests in the current snapshot are handled. As previously stated, because Read requests have their own path through the QPA 126, their request acknowledge state machine can be totally independent of the Write/RFO request handler.

The Write requests and the RFO requests share the same path through the QPA 126, and therefore the interaction of those requests has to be similar. That is, several rules should be adhered to by the queue pipes and DMA components, and the QPA 126, for fairness to work out. First, the queue pipe or DMA component can drop an RFO request line and raise a Write request line when an RFO Hold is asserted by the QPA 126 (assuming the QPA 126 has a Write request to be made). Second, the queue pipe or DMA component is not allowed to drop the Write request line and raise the RFO request line just because the RFO Hold goes away; the Write request must get serviced. Third, the QPA 126 does not take a snapshot of any RFO request until all prior RFO requests are handled. Even if no RFO requests are active, if there is a bit in the snapshot register then the QPA 126 waits for that request to become active again. While the QPA 126 is waiting, Write requests should be handled (and that snapshot register may be refreshed multiple times). Fourth, the RFO request is handled when the bit is set in the snapshot register and the RFO request is active.

The QPA 126 provides a full TxnID to the IDBM 128, as well as the EndByte Enable Valid that originated in the queue pipe or DMA components. The full TxnID is used by the IDBM tracker logic to log that a Write request has occurred. A QPA_WRReq signal is used by the IDBM 128 to differentiate between an RFO request, which will not set a tracker bit, and the Write requests, which will set a tracker bit. The Write requests are used to set the tracker bits. Also, NcWr and Message requests set a tracker bit, and Message requests do not require address information from the IDBM 128. Also, because the queue pipes and DMA components break Write requests into cache aligned Write requests, the QPA 126 should at times send the PCIe End Byte Enables and the Start Byte Enables.

There are a number of registers and counters (not shown) within the QPA 126 that assist in the operation of the QPA 126. For example, a Write/Message Request counter is an up/down counter that increments when an RFO or an NOP has been taken from any queue pipe or DMA channel, and decrements when a Write (coherent or non-coherent) or Message Completion is returned. Also, a Write/Message Request Limit is a register that contains a programmable limit beyond which no new RFO requests (actual RFOs or NOPs) are accepted by the QPA 126. Write requests still are honored because the queue pipe is responsible for insuring that no Writes are issued prior to the RFO for that line. The contents of the Write/Message Request Limit register are compared against the Write/Message Request counter to determine if the QPA 126 can accept an RFO, NcWr or Message request.

A Read Request counter is an up/down counter that increments when a Read Request (coherent or non-coherent) has been taken from any queue pipe, and decrements when a Read Completion is returned. If the Completions status indicates “Time Out,” the Read Request counter is not decremented, and the ICAM 58 keeps the location allocated indefinitely, thus keeping the location unavailable. Should the location be freed, the ICAM 58 sends a “TO Release” status, at which time the Read Request counter is decremented. Each of one or more Pipe Muxes presents the next Read and the next Write operations on Data Out lines. The next pipe select block sets the Pipe Mux for each path, based on input requests from the queue pipes. The data from the queue pipe goes to a Next Read or Next Write register.

Data from the Next Read and Next Write registers is combined with information in the registers about the transaction recalled from the ODBM 127 and the IDBM 128. At their peak, these registers are able to handle a Write/RFO request every other clock in the Write path and a Read request every fourth clock on the Read Request path. Data is formatted in these registers exactly as it will be sent to the IRQ 166.

An I/O selector directs either the Read or Write register to an IRQ input register. At the peak request rate, these registers should be capable of putting three (3) requests into the IRQ 166 every four (4) clocks (i.e., two requests (2) from the Write path and one (1) request from the Read path). To guarantee such capability, the control of the I/O selector can be no more complicated than a simple R/W toggle, with a pause when the IRQ 166 is not ready. Such configuration allows two (2) requests from the Write path and one (1) request from the Read path, which typically is what is needed for peak performance.

The DMA/RP module 42 includes other components or modules. For example, a Queue Pipe Arbiter Response Queue (QPArs) 172, which is used only in the standard PCIe Root Port (RP) mode, is responsible for moving the ICAM request responses from the queue pipes, the PSB 66 and the OTDL 98 to an Inbound Response queue (IrsQ) 174 located in the ICAM 58. Like the QPA 126, the QPArs 172 has two (2) main paths, one path from the queue pipes and the PSB 66 and the other path from the OTDL 98. The responses from the OTDL 98 are the responses for transactions that can not be mapped to a link, which result in an “Invalid Address” status for I/O or MMIO Reads or Writes.

The outbound request queue (ORQ) 168 queues outbound requests issued by the ICAM 58, as discussed hereinabove. The ORQ 168 is used only in the standard PCIe Root Port (RP) mode. The ORQ 168 maintains the order of the outbound transactions, and no requests may pass each other in the ORQ 168.

The Completions to the inbound requests are queued in the outbound response queue (ORSQ) 144. The DMA/RP module 42 makes use of the Transaction ID sent to the ICAM 58 and returned in this response to include various information, such as the OutBuf ID and the cache-line (CL) number.

When Write Completions occur, a “Write Completion” line is asserted for one (1) clock and sent to the QPA 126. In the standard PCIe Root Port (RP) mode, this signal also goes to the queue pipe that sourced the original request. This signal is used by counters in both the Root Port portions 62 and the DMA/RP portions 64 of the DMA/RP module 42. In the standard PCIe Root Port (RP) mode, Write Completions also are sent to the IDBM 128. The IDBM 128 is notified of the entire TxnID so that the appropriate cache line can be freed. In the non-standard DMA/RP mode, Write Completions are sent to the DMA input engine 162 that sourced the request, as this DMA input engine is responsible for managing and freeing buffer resources in this mode.

Read Completions also cause a one clock pulse to be sent to the QPA 126 so that the QPA 126 can maintain the Read request counter. In the standard PCIe Root Port (RP) mode, Read Completions are sent to the SCD 106 in the appropriate queue pipe. In the non-standard DMA/RP mode, Read Completions are sent to the DMA input engine 162 that sourced the request.

As indicated hereinabove, the OTDL component 98 is used only in the standard PCIe Root Port (RP) mode. The OTDL component 98 dispatches the host requests to the PSB 66. The various types of outbound transactions are sent to the appropriate PSBs 66 based on the contents of the request and the settings in the Config Registers. The OTDL component 98 also interrogates CfgRd and CfgWr operations to see if they are destined for internal Config Registers, because even CfgRd and CfgWr operations are sent to the hard core portions 56, e.g., the same as outgoing Config requests.

When data words follow the request, the data words get placed in an Outbound Request Data Buffer (ORDB) 176 by the ICAM 58, and a pointer to the data location is passed to the OTDL component 98 in the request. When data is expected with a Completion, there is a pointer to a location in the IRsDB 83 where the data is to be written.

On Read Partial commands, the OTDL component 98 is responsible for generating the Byte Enables (BEs) that are required by the PCIe Header. The ICAM 58 only passes a byte address and a length. From there, the OTDL component 98 generates the first and last BEs.

Outbound memory Write partial requests can have 64 BEs, which may be non-contiguous. The PCIe protocol allows only non-contiguous BEs on a maximum of two (2) Double Words (DWs) or one (1) quadruple word (QW), and it must be QW aligned. The OTDL component 98 is responsible for breaking the Write requests into multiple PCIe Write requests. Because Writes are posted on the PCIe link and the Completions are generated by the PSB 66, the OTDL component 98 signals the PSB 66 to suppress the Completions on Write requests that are fabricated by the OTDL component 98 and to send a Completion only on the final Write request. This Completion then goes to the ICAM 58 on the response channel.

The Outbound Request Data Buffer (ORDB) 176, which is used only in the standard PCIe Root Port (RP) mode, stores any data associated with an outbound request (e.g., an I/O, Mem, or Config Write). The PSB 66 retrieves the information from the ORDB 176 when the PSB 66 prepares to send this request to the hard core portion 56. The ORDB 176 can be is sized to accept sixteen (16) outbound 4-byte requests. The ICAM 58 is responsible for writing to the ORDB 176, and no request can be sent to the Root Port if there is not enough space in the ORDB 176.

The data associated with the inbound Read requests are stored in the ODB 102, which is a two-port buffer. The ODB 102 can be is 32K bytes in size and is organized as two separate 16K buffers. The ICAM 58 does not see the distinction and views the ODB 102 as a single buffer. The two buffers are used exclusively by a single DMA engine or queue pipe.

The Outbound Data Buffer Access (ODBA) component 104 directs data from the ODB 102 to the appropriate PSB 66. The ODBA component 104 is responsible for controlling the time share access of all the PSBs. The PSB 66 supplies the starting address to be read and the number of addresses to be read. The ODBA component 104 manages the multiple accesses and gets data to the PSB 66 in proper time. The address is set up by the PSB 66 based on the entry at the head of the Completion Queue (CQ) 96, in the standard PCIe Root Port (RP) mode, or the entry at the head of the Posted Request Queue (PRQ) 86, in the non-standard DMA/RP mode. In the standard PCIe Root Port (RP) mode, if the number of addresses to be read exceeds the end of a buffer area (e.g., a 256 byte boundary), the ODBA component 104 wraps to the start of the buffer area after reading the last location of the buffer. This wrapping process allows the data to be stored in the ODB 102 in control logic (CL) relative locations. Data DMA engines (in the non-standard DMA/RP mode) are not allowed to wrap in this manner.

The ODBA component 104 checks and corrects error correction code (ECC) on data Reads from the ODB 102. For example, the ODBA component 104 generates byte parity before the data is sent to the PSB 66. When the ODBA component 104 encounters an Uncorrectable or Poisoned ECC, the ODBA component 104 notifies the PSB 66 so that the current transfer can be stopped, e.g., by sending the tx_st_err0 signal to the hard core portion 56. The hard core portion 56 generates a PCIe-defined “nullified” TLP by inverting the LCRC (length cyclic redundancy check) and inserting an EDB (exchange server database file) symbol at the end. The PSB 66 generates a Completion with completer abort status, and all future Completions for this transaction are discarded.

The Outbound Data Buffer Manager (ODBM) 127 manages the ODB 102. The ODBM 127 supplies cache-line areas to the queue pipes and to the DMA engines and channels when requested (and if available). In the standard PCIe Root Port (RP) mode, the ODBM 127 also temporarily stores information from the PCIe memory Read request headers, e.g., in case an error detected by the ICAM 58 requires the header to be logged.

When a Read request is received by a PSB 66, the PSB 66 assigns one of its available PCIe TxnIDs, and the assigned ID is sent to the applicable queue pipe and the ODBM 127. The ODBM 127 uses this ID as an index to store the upper address bits, as well as the Requestor ID, Tag and Traffic Class. The address bits are needed by the QPA 126 when a cache-line request is generated, and the other values are needed by the PSB 66 when a Completion is returned. When a Read request reaches the IRD 142 in the queue pipe, the Read request needs a cache-line area for the request. The queue pipe raises a request to the ODBM 127 and gives the ODBM 127 the PCIe TxnID (TxnIDp) associated with this request. Also, the ODBM 127 gives the queue pipe a region of the Out Buffer specified by the OutBufID. The OutBufID is used as an index into another structure and stores the PCIe request so that when the QPA 126 requests the upper address bits, the proper area is referenced.

Once the IRD 142 has an OutBufID, the IRD 142 can then make up to two (2) 128-byte cache-line Read requests to the host memory. Because individual control logic requests are used to fill the buffer, the cache-line Read request to the host memory has no impact on the ICAM 58. If the Read request is for more than 256 bytes, multiple outbound buffers might be needed. As the IRD 142 makes Read requests to the QPA 126, the IRD 142 fills in the lower bit of the ICAM TxnID with the cache-line number in the OutBuf area. Once the Completions are returned from the ICAM 58, the queue pipe gives these IDs to the PSB 66 so that the PSB 66 can send the Completion on the PCIe interface. The queue pipe also notifies the PSB 66 if this Completion is the final Completion for this PCIe request. If the Completion is the final Completion, the TxnIDp can be reused and a flow control update incrementing the non-posted header count is sent.

The ODBM 127 also contains the Outbuf Request Completion scoreboard. When a request goes to the QPA 126, the scoreboard sets a request bit in the scoreboard. The queue pipe also notifies the QPA 126 when the queue pipe is making the final request for this particular OutBuf, and this information is relayed to the ODBM 127. When a Completion arrives in the ORSQ 144, notification and Completion status are sent to the ODBM 127, and a Completion bit is set. When the number of Completions received for a OutBufID equals the number of Requests sent, the associated “equal” status line is activated. The queue pipes are notified of the Completions received and the status of the 32 Outbuf ID areas. If the Max_payload_size is set to 128, then the SCD 106 in the queue pipe gives the PSB 66 two (2) Completions instead of one (1) Completion. These Completions are sent to the PSB 66 in address order. The first Completion signals the PSB 66 that another Completion is to follow and not to free the OutBuf ID at this time. The ODBM 127 has 64 error status lines in addition to the 32 lines that indicate “equal” status. These lines are broadcast to all queue pipes. The ODBM 127 conveys Successful, Completer Abort, Poisoned and Unsupported request status to the queue pipes using these lines, e.g., encoded as follows:

| | | Error Status |
|---|---|---|
| Status | Equal Line | Lines |
| No Status | 0 | xx |
| Successful | 1 | 00 |
| Status | | |
| UR status | 1 | 01 |
| CA status | 1 | 10 |
| Poisoned status | 1 | 11 |

The Equal line is a qualifier to the Error Status lines. The Error Status lines have no meaning if the Equal line is not set.

The Inbound Data Buffer Manager (IDBM) 128 manages access to the IDB 82 when the IOSIM 40 is set in the standard PCIe Root Port (RP) mode. The IDBM 128 is not used when the IOSIM 40 is set in the non-standard DMA/RP mode. When the IOSIM 40 is in the non-standard DMA/RP mode, buffers are managed by the DMA input channels.

Even though the memory module with which the IDBM 128 interacts is contained in the ICAM 58, its resource management is located in the Root Port. The rp_icam_rqd lines contain both an address and data, with the address being supplied by the ICAM 58. As with the ODBM 127, the IDBM 128 stores PCIe header information so that the header log can be accurately written for the cases where the ICAM 58 detects the error.

As shown, the IDBM 128 is more of a tracker than a manager. The IDB 82 usually manages on the Transaction ID. Each Transaction ID has two (2) cache-line size (256 byte) buffers associated with them. The PSB 66 uses these two areas for the three (3) possible cache-line transactions associated with a PCIe Write request. If three (3) cache-line requests are required, the first cache-line area is re-used and contains the data for both the first and last cache-line requests.

To save space in the queue pipe, the upper address bits and the Start and End BEs are stored in a structure that is indexed by the upper six (6) bits of the TxnID (for 32 total requests, only 5 bits are required). Whenever the PSB 66 receives a new PCIe Write transaction, the PSB 66 assigns a TxnID and sends the information to be stored in the IDBM 128 with that TxnID.

When a Write Completion is sent to the ORSQ 144, the ORSQ 144 sends the TxnID to the IDBM 128. When the IDBM 128 receives a TxnID, the IDBM 128 clears the associated bit in the tracker and then checks the Index to see if all three (3) bits are now clear. If so, the TxnID is returned to the PSBs 66 for reuse. The TxnIDs are broadcast to all PSBs, and the individual PSBs determine if in their current configuration they own the particular broadcast ID or not. If the PSB owns the ID, the PSB adds the ID to their ID available queue, and increments a posted header credit counter, which will get sent to the device with the next update.

The IDBM 128 does not have to timeout requests that have aged. It is expected that the ICAM 58 times all requests, and if the ICAM 58 times out a request, the ICAM 58 responds on the response channel with a Completion having a status of “Timed Out.” A Time Out Completion clears a tracker location in the same manner as a successful Completion. The error is expected to be logged by the ICAM 58.

The IB Mux 78 controls the PSB address/data access to the IDB 82. Prior to writing data to the IDB 82, the IB Mux 78 checks parity and generates ECC. Because it is too late to stop a Write request from leaving the PSB 66 in the event of a parity error Poisoned ECC, the Write request is generated and written to the IDB 82. In this case, an Inbound Data PE is flagged as a Non-Correctable error with severity programmable to be either fatal or non-fatal. Because the IRsDB 83 is parity protected, there is no need for the IB Mux 78 to parity check this data; the data is checked by the ICAM 58 when read. The IB Mux 78 passes the data and parity unaltered to the IRsDB 83.

There is no logic interlock between the data path writing to the IDB 82 or the IRsDB 83 and the request path through the queue pipe. The design is timing verified to guarantee that data is written into these buffers prior to being sent through the QPA 126 to the ICAM 58. The design is this way because there are many more tasks to be executed prior to issuance of a Write request or forwarding a Completion than to write the data to its buffer. However, it must be explicitly verified that the worst case timing to write the last data exceeds the best case time for a request to be processed through the queue pipe and the QPA 126.

The ICAM 58 is a common module that is used identically in both the standard PCIe Root Port (RP) mode of operation and the non-standard DMA/RP mode of operation. As discussed previously hereinabove, the ICAM 58 interfaces with the DMA/RP module 42 on one side and the LIFs 44 and HSS blocks 46 on the other side.

The ICAM 58 provides the fully buffered queues for packets destined for the DMA/RP module 42. The LIFs 44 and the HSS blocks 46 provide fully buffered queues for packets from the ICAM 58. The IOSIM 40 owns any cache lines in the host system interface protocol and this ownership is controlled and managed by the ICAM 58. The ICAM 58 includes two major blocks (not shown): an ICAM Outbound Block (ICAMo) to service outbound requests, and an ICAM Inbound Block (ICAMi) for servicing snoop requests and inbound requests from the DMA/RP module 42.

The methods illustrated and described herein may be implemented in a general, multi-purpose or single purpose processor. Such a processor will execute instructions, either at the assembly, compiled or machine-level, to perform that process. Those instructions can be written by one of ordinary skill in the art following the description of the methods described herein and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), and the like.

It will be apparent to those skilled in the art that many changes and substitutions can be made to the embodiments described herein without departing from the spirit and scope of the disclosure as defined by the appended claims and their full scope of equivalents.

1. A module apparatus for use in an input/output (I/O) system interconnect module (IOSIM) device, comprising:
an I/O Caching Agent Module (ICAM);
at least one PCIe service block (PSB);
a Root Port (RP) portion coupled between the ICAM and the at least one PSB; and
at least one DMA/RP portion coupled between the ICAM and the at least one PSB,
wherein the RP portion is configured to allow the IOSIM device to function as a PCIe Root Port device, and
wherein the DMA/RP portion is configured to provide a direct memory access (DMA) functionality to the IOSIM in such a way that allows the IOSIM to function as an end point device.

2. The apparatus as recited in claim 1, wherein the RP portion includes a plurality of queue pipes coupled to the PSB, wherein the queue pipes are configured to maintain the order of PCI information passing through the RP portion when the IOSIM device is functioning as a PCIe Root Port device, wherein the PCI information includes memory Reads, memory Writes, messages, instructions, Request for Ownership (RFO) transactions and Completions.

3. The apparatus as recited in claim 1, wherein the DMA/RP portion includes a plurality of DMA engines and DMA channels, wherein the DMA engines and DMA channels are configured to transfer data between a host memory coupled to IOSIM via the ICAM and an I/O processor (IOP) coupled to the IOSIM via the PSB, wherein the transferred data includes memory Reads, memory Writes, descriptor Fetch commands, descriptor Writebacks, Request for Ownership (RFO) transactions and Completions.

4. The apparatus as recited in claim 1, wherein the PSB includes a first plurality of queues configured for processing any transaction layer packets (TLPs) generated by the RP portion when the IOSIM device is functioning as a PCIe Root Port device.

5. The apparatus as recited in claim 1, wherein the PSB includes a second plurality of queues configured for processing DMA Descriptor Fetch operations and DMA Descriptor Writeback operations when the IOSIM device is functioning as an end point device.

6. The apparatus as recited in claim 1, wherein the IOSIM operates in a standard RP mode of operation when the RP portion functions as a PCIe Root Port device and wherein the IOSIM operates in a non-standard DMA/RP mode of operation when the IOSIM functions as an end point device.

7. The apparatus as recited in claim 1, wherein the module apparatus includes a hard core portion coupled to a corresponding PSB, wherein the hard core portion couples the module apparatus and the IOSIM to at least one I/O device coupled to the IOSIM via at least one of an I/O processor (IOP) within the I/O device and an IO manager within the I/O device.

8. The apparatus as recited in claim 1, wherein the RP portion allows the IOSIM to be used in a Peripheral Component Interconnect Express (PCIe) bus standard I/O systems.

9. The apparatus as recited in claim 1, wherein the DMA/RP portion allows the IOSIM to be used with a non-standard PCIe I/O system configured to operate in a computing environment that includes a Master Control Program (MCP) environment.

10. An input/output (I/O) system interconnect module (IOSIM) device, wherein the IOSIM is configured to be coupled between at least one memory control device (MCD) within a host memory device and at least one PCIe link to an I/O device, wherein the IOSIM device comprises:
at least one link interface (LIF) configured to be coupled to the at least one MCD;
at least one DMA/RP module coupled to the at least one LIF;
at least one high speed serial link (HSS) coupled to the at least one LIF and coupled to the DMA/RP module; and
a maintenance service block coupled to the DMA/RP module, coupled to the at least one LIF, and coupled to the at least one HSS,
wherein the DMA/RP module includes
an I/O Caching Agent Module (ICAM),
at least one PCIe service block (PSB),
a Root Port (RP) portion coupled between the ICAM and the at least one PSB, and
at least one DMA/RP portion coupled between the ICAM and the at least one PSB,
wherein the RP portion is configured to allow the IOSIM device to function as a PCIe Root Port device, and
wherein the DMA/RP portion is configured to provide a direct memory access (DMA) functionality to the IOSIM in such a way that allows the IOSIM to function as an end point device.

11. The system as recited in claim 10, wherein the RP portion includes a plurality of queue pipes coupled to the PSB, wherein the queue pipes are configured to maintain the order of PCI information passing through the RP portion when the IOSIM device is functioning as a PCIe Root Port device, wherein the PCI information includes memory Reads, memory Writes, messages, instructions, Request for Ownership (RFO) transactions and Completions.

12. The system as recited in claim 10, wherein the DMA/RP portion includes a plurality of DMA engines and DMA channels, wherein the DMA engines and DMA channels are configured to transfer data between the host memory coupled to IOSIM via the ICAM and an I/O processor (IOP) within the I/O device coupled to the IOSIM via the PSB, wherein the transferred data includes memory Reads, memory Writes, descriptor Fetch commands, descriptor Writebacks, Request for Ownership (RFO) transactions and Completions.

13. The system as recited in claim 10, wherein the PSB includes a first plurality of queues configured for processing any transaction layer packets (TLPs) generated by the RP portion when the IOSIM device is functioning as a PCIe Root Port device.

14. The system as recited in claim 10, wherein the PSB includes a second plurality of queues configured for processing DMA Descriptor Fetch operations and DMA Descriptor Writeback operations when the IOSIM device is functioning as an end point device.

15. The system as recited in claim 10, wherein the IOSIM operates in a standard RP mode of operation when the RP portion functions as a PCIe Root Port device and wherein the IOSIM operates in a non-standard DMA/RP mode of operation when the IOSIM functions as an end point device.

16. The system as recited in claim 10, wherein the DMA/RP module includes a hard core portion coupled to a corresponding PSB, wherein the hard core portion couples the module apparatus and the IOSIM to at least one I/O device coupled to the IOSIM via at least one of an I/O processor (IOP) within the I/O device and an IO manager within the I/O device.

17. The system as recited in claim 10, wherein the RP portion allows the IOSIM to be used in a Peripheral Component Interconnect Express (PCIe) bus standard I/O systems.

18. The system as recited in claim 10, wherein the DMA/RP portion allows the IOSIM to be used with a non-standard PCIe I/O system configured to operate in a computing environment that includes a Master Control Program (MCP) environment.

19. The system as recited in claim 10, wherein the ICAM is configured to transition data from a non-coherent PCIe space to a coherent space to a host operating system within the host memory device.

20. The system as recited in claim 10, wherein the IOSIM operates in a standard RP mode of operation when the RP portion functions as a PCIe Root Port device and wherein the IOSIM operates in a non-standard DMA/RP mode of operation when the IOSIM functions as an end point device.

21. The system as recited in claim 20, wherein the IOSIM is configured to switch the DMA/RP module between a standard PCIe Root Port (RP) mode of operation and a non-standard DMA/RP mode of operation.

22. The system as recited in claim 21, wherein the DMA/RP module is configured to switch between the standard PCIe Root Port (RP) mode of operation and the non-standard DMA/RP mode of operation IOSIM by switching a pin strap setting within the DMA/RP module.
